(19) United States
(12) Patent Application Publication
(10) Pub. No.: US 2021/0182701 A1
(43) Pub. Date: Jun. 17, 2021

(54) VIRTUAL DATA SCIENTIST WITH PRESCRIPTIVE ANALYTICS

(71) Applicant: Accenture Global Solutions Limited, Dublin (IE)

(72) Inventors: Senthilkumar JEYACHANDRAN, Chennai (IN); Rajesh NAGARAJAN, Chennai (IN); Koushik M. VIJAYARAGHAVAN, Chennai (IN); Sheeba DULLES, Chennai (IN); Jayashri SRIDEVI, Chennai (IN); Avenash MANICAN GANESHBAPU, Chennai (IN); Rajendra T. PRASAD, Basking Ridge, NJ (US); Bhaskar GHOSH, Bengaluru (IN); Mohan SEKHAR, Bangalore (IN); Aditi KULKARNI, Bengaluru (IN); Luke HIGGINS, West Pymble (AU)

(21) Appl. No.: 16/717,017

(22) Filed: Dec. 17, 2019

(51) Int. Cl. G06N 5/04; G06N 20/00

(52) U.S. Cl. CPC G06N 5/04; G06N 20/00

(57) ABSTRACT

A data analytics platform may determine whether a machine learning model is a regression model. The data analytics platform may perform, based on determining that the machine learning model is a regression model, a regression prescription method including acquiring a predicted value of a performance indicator determined by the machine learning model processing data associated with a plurality of features and the performance indicator, acquiring a target value of the performance indicator, determining a rate of change of the performance indicator with respect to each feature to generate first results, determining, based on the regression model and for each feature, a rate of change of each feature with respect to other features to generate second results, and determining, for each feature and based on the predicted value, the target value, the first results, and the second results, a change in each feature to achieve the target value.

### BACKGROUND

Data analytics involves using data to discover useful information, inform conclusions, and/or support decision-making. For example, an entity may collect data and use data analytics to monitor one or more functions of the entity, make decisions, and/or the like.

### SUMMARY

According to some implementations, a method may include determining, by a device, whether a machine learning model is a regression model to obtain a determination that the machine learning model is a regression model or a determination that the machine learning model is not a regression model; performing, by the device and based on a determination that the machine learning model is a regression model, a regression prescription method, wherein the regression prescription method includes: acquiring a predicted value of a performance indicator, wherein the predicted value of the performance indicator is determined by the machine learning model processing data associated with a plurality of features and the performance indicator, acquiring a target value of the performance indicator, determining, based on the regression model, a rate of change of the performance indicator with respect to each feature of the plurality of features to generate first results, determining, based on the regression model and for each feature of the plurality of features, a rate of change of each feature with respect to other features of the plurality of features to generate second results, and determining, for each feature of the plurality of features and based on the predicted value of the performance indicator, the target value of the performance indicator, the first results, and the second results, a change in each feature to achieve the target value of the performance indicator.

According to some implementations, a device may include one or more memories; and one or more processors, communicatively coupled to the one or more memories, configured to: determine whether a machine learning model is a regression model to obtain a determination that the machine learning model is a regression model or a determination that the machine learning model is not a regression model; perform, based on a determination that the machine learning model is a regression model, a regression prescription method, wherein the regression prescription method includes: acquiring a predicted value of a performance indicator associated with a process, wherein the predicted value of the performance indicator is determined by the machine learning model processing data associated with a plurality of features associated with the process and the performance indicator, acquiring a target value of the performance indicator, determining, based on the regression model, a rate of change of the performance indicator with respect to each feature of the plurality of features to generate first results, determining, based on the regression model and for each feature of the plurality of features, a rate of change of each feature with respect to other features of the plurality of features to generate second results, and determining, for each feature of the plurality of features and based on the predicted value of the performance indicator, the target value of the performance indicator, the first results, and the second results, a change in each feature to achieve the target value of the performance indicator; and generate, based on the change in each feature to achieve the target value of the performance indicator, a recommendation to change the process to achieve the target value of the performance indicator.

According to some implementations, a non-transitory computer-readable medium may store one or more instructions. The one or more instructions, when executed by one or more processors, may cause the one or more processors to: determine whether a machine learning model is a regression model to obtain a determination that the machine learning model is a regression model or a determination that the machine learning model is not a regression model, wherein the machine learning model processes data associated with a plurality of features and a performance indicator to determine a predicted value of the performance indicator; perform, based on a determination that the machine learning model is a regression model, a regression prescription method, wherein the regression prescription method includes: acquiring the predicted value of the performance indicator, acquiring a target value of the performance indicator, determining, based on the regression model, a rate of change of the performance indicator with respect to each feature of the plurality of features to generate first results, determining, based on the regression model and for each feature of the plurality of features, a rate of change of each feature with respect to other features of the plurality of features to generate second results, and determining, for each feature of the plurality of features and based on the predicted value of the performance indicator, the target value of the performance indicator, the first results, and the second results, a change in each feature to achieve the target value of the performance indicator; perform, based on a determination that the machine learning model is not a regression model, a classification prescription method, wherein the classification prescription method includes: acquiring the predicted value of the performance indicator, acquiring the target value of the performance indicator, determining whether the plurality of features are numerical, and based on determining that the plurality of features are not numerical: obtaining, using a model explainer, feature importance information, and determining, based on the feature importance information, a change in each feature to achieve the target value of the performance indicator, or based on determining that the plurality of features are numerical, performing the regression prescription method to determine a change in each feature to achieve the target value of the performance indicator; and generate, based on the change in each feature to achieve the target value of the performance indicator, a recommendation to change a process to achieve the target value of the performance indicator.

### BRIEF DESCRIPTION OF THE DRAWINGS

FIGS. 1A-1F are diagrams of one or more example implementations described herein.

FIG. 2 is a diagram of an example environment in which systems and/or methods described herein may be implemented.

FIG. 3 is a diagram of example components of one or more devices of FIG. 2.

FIG. 4 is a flow chart of an example process for determining a change in one or more features to achieve a target value of a performance indicator.

FIGS. 5-6 are flow charts of example processes for generating a recommendation to change a process to achieve a target value of a performance indicator.

### DETAILED DESCRIPTION

The following detailed description of example implementations refers to the accompanying drawings. The same reference numbers in different drawings may identify the same or similar elements.

An entity may collect large amounts of data regarding processes performed within and/or by the entity. For example, the data may include a start date of a process, a completion date of the process, resources consumed by the process, employees involved in the process, and/or the like. The entity may provide the data to a descriptive analytics system to obtain historical information regarding the process. The entity may also provide the data to a predictive analytics system to obtain forecasts regarding the process (e.g., estimated dates of completion, estimated resources to be consumed by the process, and/or the like). However, the forecasts generated by the predictive analytics system merely provide insight to the entity regarding what may happen in the future if the entity continues to perform the process in the same manner that the entity has been performing the process. If the entity, in an effort to determine how to achieve a goal, provided the predictive analytics system with speculative data to simulate a change to the process, the predictive analytics system may provide a forecast based on the change, which the entity may use to determine whether the change would achieve the goal. However, given the large amount of data that the entity collects, to obtain a forecast for a change that achieves the goal, the entity would likely need to simulate hundreds, thousands, or even millions of changes, which would consume computing resources (e.g., processing resources, memory resources, power resources, communication resources, and/or the like) and/or network resources.

Some implementations described herein provide a data analytics system that determines, based on a predictive analytics model, changes to features of a process that would achieve a target value of a performance indicator, and generates a recommendation to change the process to achieve the target value of the performance indicator. In some implementations, the data analytics system may train, using historical data, a machine learning model to determine a predicted value of the performance indicator. In some implementations, the data analytics system may process, using the machine learning model, data associated with a plurality of features and the performance indicator, to determine a predicted value of the performance indicator. In some implementations, the data analytics system may acquire a target value of the performance indicator and may determine whether the machine learning model is a regression model. In some implementations, the data analytics system may, based on determining that the machine learning model is a regression model, perform a regression prescription method to determine a change in each feature to achieve the target value of the performance indicator. In some implementations, the data analytics system may, based on determining that the machine learning model is not a regression model, perform a classification prescription method to determine a change in each feature to achieve the target value of the performance indicator. By using the regression prescription method and/or the classification prescription method to determine a change in each feature to achieve the target value of the performance indicator, the data analytics system may conserve computing resources (e.g., processing resources, memory resources, power resources, communication resources, and/or the like) and/or network resources that would otherwise be consumed by repeatedly simulating changes using the machine learning model until the predicted value matched the target value. Furthermore, the data analytics system may provide the entity with one or more recommendations for changing a process to achieve a goal.

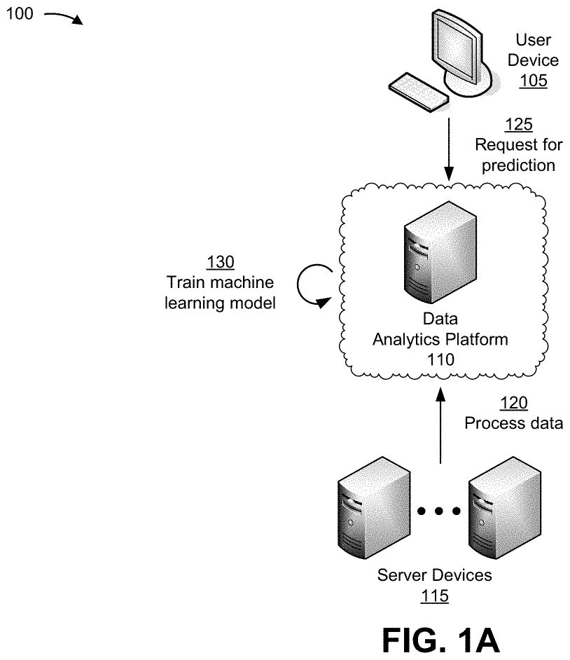

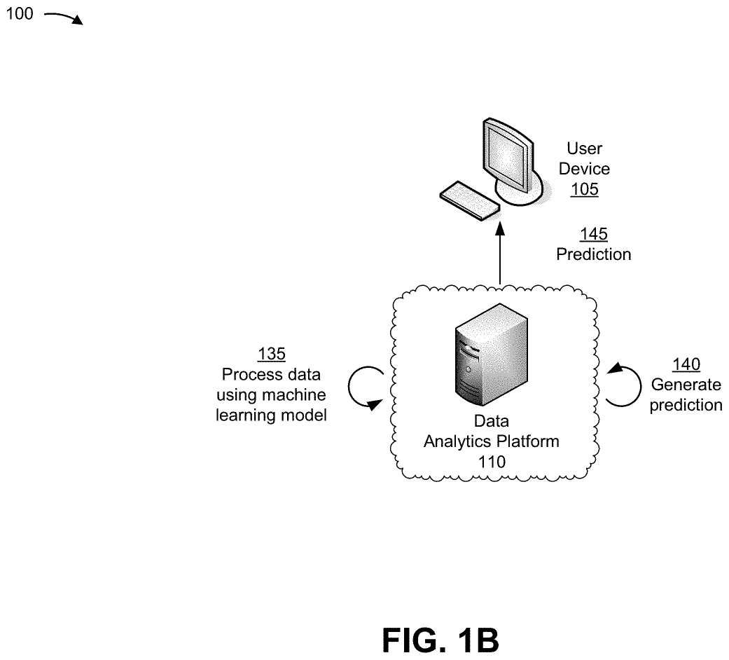

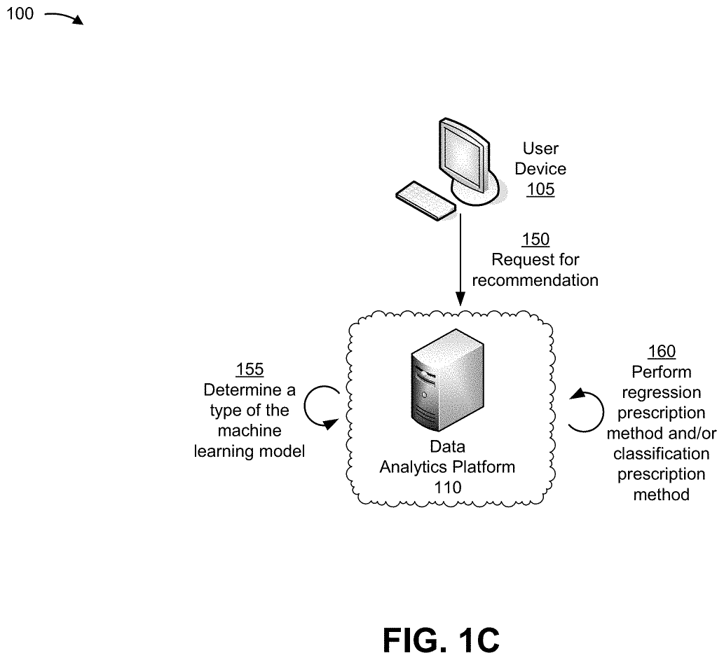

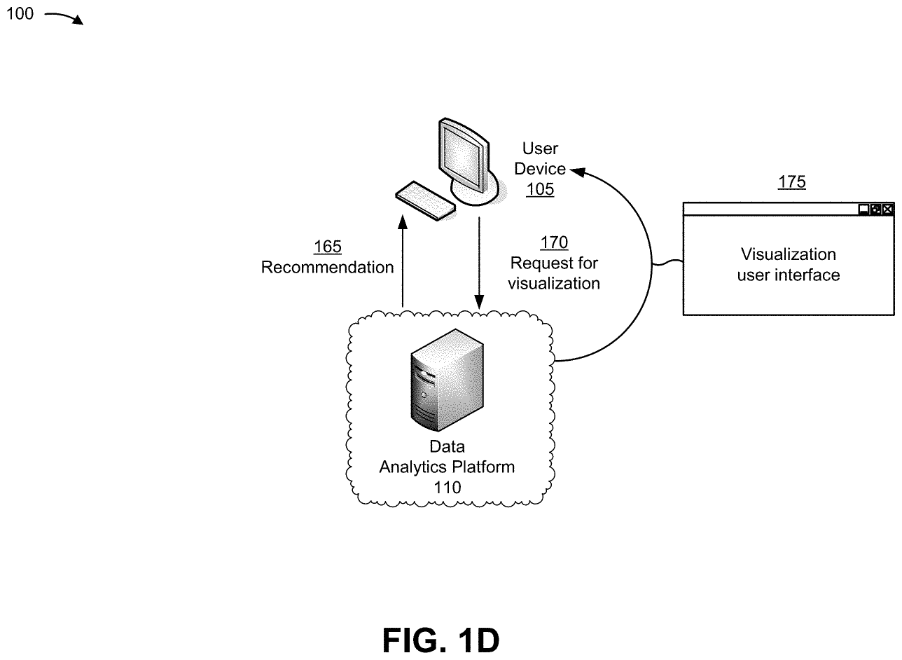

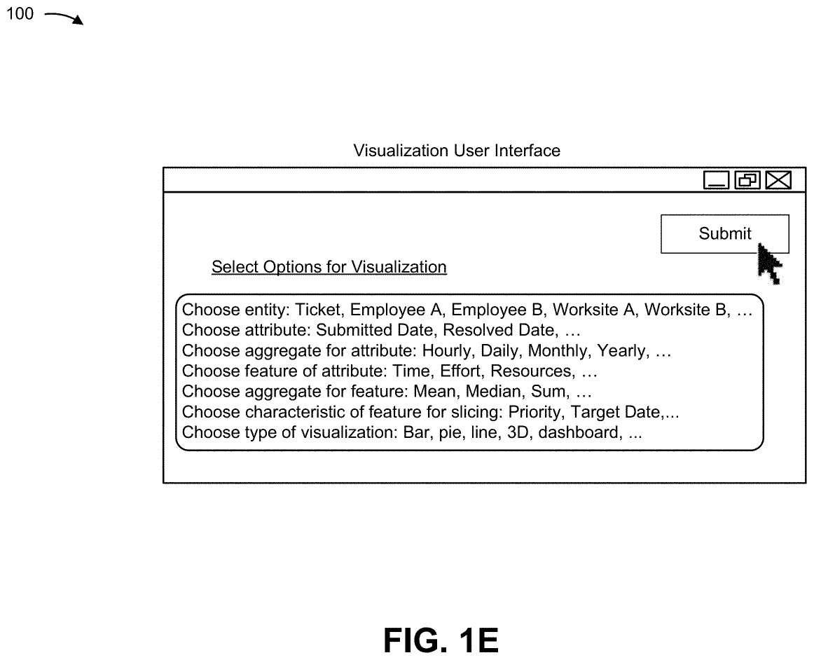

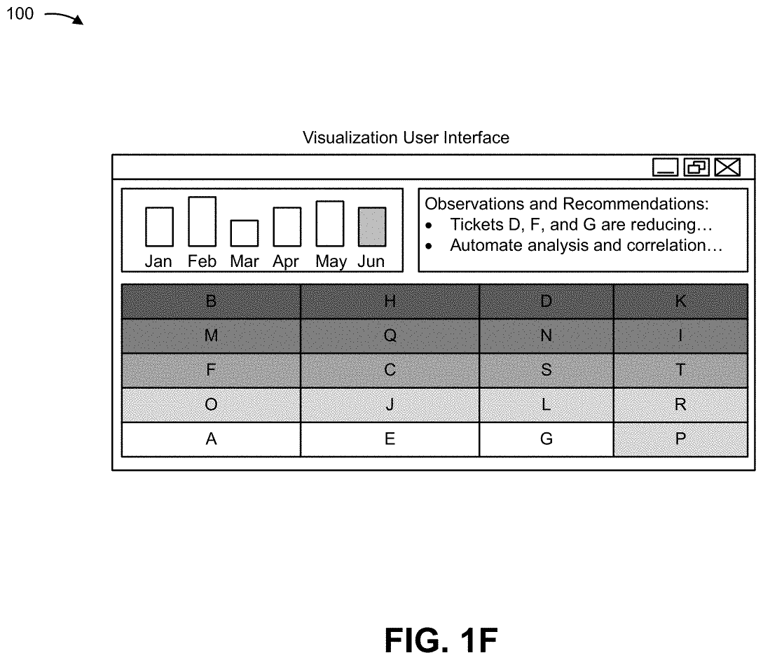

FIGS. 1A-1F are diagrams of one or more example implementations 100 described herein. For example, as shown in FIGS. 1A-1F, example implementation(s) 100 may include a user device 105, a data analytics platform 110, and one or more server devices 115.

As shown in FIG. 1A, and by reference number 120, the data analytics platform 110 may obtain process data. For example, the data analytics platform 110 may obtain process data from one or more server devices 115 storing historical process data relating to a set of processes previously performed (e.g., by an entity, using a set of automated tools, by a set of employees, and/or the like). Additionally, or alternatively, the data analytics platform 110 may obtain process data in real-time or near real-time, such as based on a new process being instantiated in a project monitored by the data analytics platform 110, based on one or more changes to process data on a source data structure, and/or the like. In some implementations, the data analytics platform 110 may provide a web-based user interface to receive process data, receive user feedback, provide results of performing an assessment, and/or the like.

In some implementations, the data analytics platform 110 may obtain process data from disparate source systems (e.g., different applications, different data storage systems, and/or the like). In some implementations, the data analytics platform 110 may transform the process data from disparate source systems into a particular data format for storage (e.g., in a data structure, on the server devices 115, on the user device 105, and/or the like).

In some implementations, the process data may include data that an entity has collected regarding a process performed within and/or by the entity. For example, the process may include a service delivery process, a software engineering process, a software testing process, a development operations process, an agile process, an industry practices process, a process management process, a project management process, and/or the like.

In some implementations, the process data may include data associated with a plurality of features associated with the process and/or data associated with a performance indicator associated with the process. In some implementations, the plurality of features may include a number of people working on the process, time spent on the process, financial resources consumed by the process, data storage used by the process, one or more subprocesses of the process, whether or not the process and/or one or more subprocesses are automated, and/or the like.

In some implementations, the performance indicator may include a measure of performance used by the entity to assess the performance of the entity on the process, such as a metric, performance indicator, and/or the like. For example, the performance indicator may be a value calculated based on the process data, the plurality of features, and/or the like. In some implementations, the performance indicator may be a total number of tickets resolved in a time period, an average time to resolve tickets, a customer feedback rating, total resources (e.g., computer resources, financial resources, and/or the like) consumed to complete the process, and/or the like.

In some implementations, the data analytics platform 110 may generate visualizations of the process data for the user device 105. For example, the data analytics platform 110 may receive, from the user device 105, a request to generate a visualization of the process data. In some implementations, the data analytics platform 110 may receive, from the user device 105, selections of an entity associated with the plurality of features, an attribute of the entity, an aggregate for the attribute, a feature, of the plurality of features, of the attribute, an aggregate for the feature, a characteristic of a feature by which the data may be sliced, a type of visualization (e.g., a chart, a bar graph, a line graph, a three-dimensional representation, and/or the like), and/or the like. For example, to generate a chart on ticket data showing total effort spent monthly in resolving tickets sliced by priority, the user device 105 may provide and the data analytics platform 110 may receive selections of “ticket” for the entity associated with the plurality of features, “resolved date” for the attribute of the entity, “monthly” for the aggregate for the attribute, “effort” for the feature, of the plurality of features, of the attribute, “sum” for the aggregate for the feature, “priority” for the characteristic of a feature by which the data may be sliced, and “chart” for the type of visualization. In some implementations, the data analytics platform 110 may process the data associated with the plurality of features and the performance indicator to generate, based on the selections, a visualization of the data associated with the selections. In some implementations, the data analytics platform 110 may display the visualization, provide the visualization to the user device 105 (e.g., for storing, for display, and/or the like), and/or the like. In this way, the data analytics platform 110 may provide descriptive analytics.

As shown in FIG. 1A, and by reference number 125, the user device 105 may provide, to the data analytics platform 110, a request for a prediction. In some implementations, the user device 105 may provide, to the data analytics platform 110, a request for a predicted value of a performance indicator associated with a process (e.g., a predicted value of the performance indicator after one or more periods of time into the future (e.g., a week, a month, a year, and/or the like), a predicted value of the performance indicator on a date in the future, and/or the like). For example, the user device 105 may provide, to the data analytics platform 110, a request for a predicted number of tickets to be resolved in the next month.

As shown in FIG. 1A, and by reference number 130, the data analytics platform 110 may train a machine learning model. As described herein, the data analytics platform 110 may use one or more artificial intelligence techniques, such as machine learning, deep learning, and/or the like to determine relationships between features of the process and the performance indicator and determine, based on the relationships, a predicted value of a performance indicator.

In some implementations, the data analytics platform 110 may parse natural language descriptions of historical information for a plurality of implementations of the process. For example, the data analytics platform 110 may obtain data (e.g., the process data) identifying, in natural language, descriptions of historical information for the plurality of implementations of the process (e.g., features of each implementation of the process and/or the like), a plurality of historical outcomes of the implementations of the process (e.g., values of the performance indicator and/or the like), and/or the like, and may parse the data to identify features associated with the performance indicator.

In some implementations, the data analytics platform 110 may determine a characteristic of a feature based on natural language processing of the historical information, which may include a description of the feature. For example, based on a description of a feature being associated with the performance indicator, the data analytics platform 110 may use natural language processing to determine that a characteristic of the feature is that the feature is associated with the performance indicator. Similarly, based on a description of the feature being described as not being associated with the performance indicator, the data analytics platform 110 may use natural language processing to determine that a characteristic of the feature is that the feature is not associated with the performance indicator, and/or the like. In this case, the data analytics platform 110 may determine that a natural language text corresponds to a characteristic of a feature based on data relating to other characteristics of features, data identifying characteristics of features, and/or the like.

In this way, the data analytics platform 110 may identify characteristics of features associated with the performance indicator, as described herein. Based on applying a rigorous and automated process associated with determining whether a feature is associated with the performance indicator, the data analytics platform 110 enables recognition and/or identification of thousands, millions, billions, or trillions of features, thereby increasing an accuracy and consistency of identifying features associated with the performance indicator relative to requiring computing resources to be allocated for hundreds or thousands of technicians to manually identify features associated with the performance indicator of the thousands, millions, billions, or trillions of features.

In some implementations, the data analytics platform 110 may determine whether a feature is or can be associated with the performance indicator, as described herein. For example, using historical information, the data analytics platform 110 may determine a relationship between a feature and the performance indicator. In this case, the data analytics platform 110 may generate a performance predicting model. For example, the data analytics platform 110 may train a model using historical information that includes a plurality of implementations of the process (e.g., features of each implementation of the process and/or the like), a plurality of historical outcomes of the implementations of the process (e.g., values of the performance indicator and/or the like), and/or the like to determine a relationship between a feature and the performance indicator. As an example, the data analytics platform 110 may determine that past features are associated with a threshold probability of being associated with the performance indicator. In some implementations, the data analytics platform 110 may use a scoring system (e.g., with relatively high scores and/or relatively low scores) to identify and/or classify features as being associated with one another. In this case, the data analytics platform 110 may determine that a relatively high score (e.g., as being likely to be associated with the performance indicator) is to be assigned to features that are determined to be the same or similar as previously identified features of the particular feature (or more frequently identified than past identified features). In contrast, the data analytics platform 110 may determine that a relatively low score (e.g., as being unlikely to be associated with the performance indicator) is to be assigned to features that are determined to be different than past identified features of the particular feature (or less frequently identified than past identified features).

In some implementations, the data analytics platform 110 may perform a data preprocessing operation when generating the performance predicting model. For example, the data analytics platform 110 may preprocess data (e.g., the process data, historical information that includes a plurality of implementations of the process (e.g., features of each implementation of the process and/or the like), a plurality of historical outcomes of the implementations of the process (e.g., values of the performance indicator and/or the like), and/or the like) to remove non-ASCII characters, white spaces, confidential data (e.g., personal information, medical information, and/or the like), and/or the like. In this way, the data analytics platform 110 may organize thousands, millions, or billions of data items for machine learning and model generation.

In some implementations, the data analytics platform 110 may perform a training operation when generating the performance predicting model. For example, the data analytics platform 110 may portion data of the historical information into a training set (e.g., a set of data to train the model), a validation set (e.g., a set of data used to evaluate a fit of the model and/or to fine tune the model), a test set (e.g., a set of data used to evaluate a final fit of the model), and/or the like. In some implementations, the data analytics platform 110 may preprocess and/or perform dimensionality reduction to reduce the data of the historical information to a minimum feature set. In some implementations, the data analytics platform 110 may train the performance predicting model on this minimum feature set, thereby reducing processing to train the machine learning model, and may apply a classification technique, to the minimum feature set.

In some implementations, the data analytics platform 110 may use a classification technique, such as a logistic regression classification technique, a random forest classification technique, a gradient boosting machine learning (GBM) technique, and/or the like, to determine a categorical outcome (e.g., that a feature is associated with the performance indicator, that a feature is not associated with the performance indicator, and/or the like). Additionally, or alternatively, the data analytics platform 110 may use a naive Bayesian classifier technique. In this case, the data analytics platform 110 may perform binary recursive partitioning to split the data of the minimum feature set into partitions and/or branches and use the partitions and/or branches to perform predictions (e.g., that a feature is associated with the performance indicator, that a feature is not associated with the performance indicator, and/or the like). Based on using recursive partitioning, the data analytics platform 110 may reduce utilization of computing resources relative to manual, linear sorting and analysis of data items, thereby enabling use of thousands, millions, or billions of data items to train a model, which may result in a more accurate model than using fewer data items.

Additionally, or alternatively, the data analytics platform 110 may use a support vector machine (SVM) classifier technique to generate a non-linear boundary between data items in the training set. In this case, the non-linear boundary is used to classify test data (e.g., data relating features) into a particular class (e.g., a class indicating that the feature is associated with the performance indicator, a class indicating that the feature is not associated with the performance indicator, and/or the like).

Additionally, or alternatively, where the test data includes image data, video data, and/or the like, the data analytics platform 110 may use a computer vision technique, such as a convolutional neural network technique to assist in classifying test data (e.g., data relating features) into a particular class (e.g., a class indicating that the feature is associated with the performance indicator, a class indicating that the feature is not associated with the performance indicator, and/or the like). In some cases, the computer vision technique may include using an image recognition technique (e.g., an Inception framework, a ResNet framework, a Visual Geometry Group (VGG) framework, and/or the like), an object detection technique (e.g., a Single Shot Detector (SSD) framework, a You Only Look Once (YOLO) framework, and/or the like), an object in motion technique (e.g., an optical flow framework and/or the like), and/or the like.

Additionally, or alternatively, the data analytics platform 110 may train the performance predicting model using a supervised training procedure that includes receiving input to the model from a subject matter expert, which may reduce an amount of time, an amount of processing resources, and/or the like to train the performance predicting model relative to an unsupervised training procedure. In some implementations, the data analytics platform 110 may use one or more other model training techniques, such as a neural network technique, a latent semantic indexing technique, and/or the like. For example, the data analytics platform 110 may perform an artificial neural network processing technique (e.g., using a two-layer feedforward neural network architecture, a three-layer feedforward neural network architecture, and/or the like) to perform pattern recognition with regard to patterns of whether features described using different semantic descriptions can be used to determine whether features are associated with the performance indicator. In this case, using the artificial neural network processing technique may improve an accuracy of a model (e.g., the performance predicting model) generated by the data analytics platform 110 by being more robust to noisy, imprecise, or incomplete data, and by enabling the data analytics platform 110 to detect patterns and/or trends undetectable to human analysts or systems using less complex techniques.

As an example, the data analytics platform 110 may use a supervised multi-label classification technique to train the model. For example, as a first step, the data analytics platform 110 may map parameters to a feature. In this case, the parameters may be characterized as associated with the performance indicator or not associated with the performance indicator based on characteristics of the parameters (e.g., whether a characteristic of a parameter is similar or associated with a characteristic of the feature) and an analysis of the parameters (e.g., by a technician, thereby reducing processing relative to the data analytics platform 110 being required to analyze each activity). As a second step, the data analytics platform 110 may determine classifier chains, whereby labels of target variables may be correlated (e.g., in this example, labels may be parameters and correlation may refer to a common characteristic of a feature). In this case, the data analytics platform 110 may use an output of a first label as an input for a second label (as well as one or more input features, which may be other data relating to the features), and may determine a likelihood that a particular parameter that includes a set of characteristics (some of which are associated with a particular feature and some of which are not associated with the particular feature) are associated with the particular feature based on a similarity to other parameters that include similar characteristics. In this way, the data analytics platform 110 transforms classification from a multilabel-classification problem to multiple single-classification problems, thereby reducing processing utilization. As a third step, the data analytics platform 110 may determine a Hamming loss metric relating to an accuracy of a label in performing a classification by using the validation set of the data. For example, an accuracy with which a weighting applied to each parameter and whether each parameter is associated with a feature or not, results in a correct prediction of whether a feature is associated with the performance indicator or not, thereby accounting for differing amounts to which association of any one parameter influences being associated with the performance indicator or not. As a fourth step, the data analytics platform 110 may finalize the model based on labels that satisfy a threshold accuracy associated with the Hamming loss metric and may use the model for subsequent prediction of whether parameters of a feature are to result in an association with the performance indicator.

As another example, the data analytics platform 110 may determine, using a linear regression technique, that a threshold percentage of features, in a set of features, are not associated with the performance indicator, and may determine that those features are to receive relatively low association scores. In contrast, the data analytics platform 110 may determine that another threshold percentage of features are associated with the performance indicator and may assign a relatively high association score to those features. Based on the features being associated with the performance indicator or not, the data analytics platform 110 may generate the performance predicting model and may use the performance predicting model for analyzing new features and/or the like that the data analytics platform 110 identifies.

In some implementations, a different device, such as a server device, may generate and train the model. The different device may send the model for use by the data analytics platform 110. The different device may update and send (e.g., on a scheduled basis, on an on-demand basis, on a triggered basis, on a periodic basis, and/or the like) the model to the data analytics platform 110.

Accordingly, the data analytics platform 110 may use any number of artificial intelligence techniques, machine learning techniques, deep learning techniques, and/or the like to determine whether features are associated with the performance indicator and relationships between the features and the performance indicator.

As shown in FIG. 1B, and by reference number 135, the data analytics platform 110 may process data using a machine learning model. For example, the data analytics platform 110 may process data using the performance predicting model. In some implementations, the data may include process data obtained in real-time or near real-time from the server devices 115 and/or the user device 105. For example, the data analytics platform 110 may process, using the performance predicting model, data that is different from and/or newer than the data used to train the performance predicting model.

As shown in FIG. 1B, and by reference number 140, the data analytics platform 110 may generate a prediction. In some implementations, the data analytics platform 110 may, based on the processing using the performance predicting model, generate a predicted value of the performance indicator identified in the request for the prediction provided by the user device 105 to the data analytics platform 110. For example, if the user device 105 requested the predicted number of tickets resolved in the next month, the data analytics platform 110 may, using the performance predicting model, generate a predicted value for the number of tickets resolved in the next month.

As shown in FIG. 1B, and by reference number 145, the data analytics platform 110 may provide, to the user device 105, the prediction. In some implementations, the data analytics platform 110 may provide, to the user device 105, the predicted value of the performance indicator identified in the request. For example, the data analytics platform 110 may provide the predicted value to the user device 105.

Additionally, or alternatively, the data analytics platform 110 may generate and/or provide, to the user device 105, a visualization that includes the prediction. For example, the data analytics platform 110 may generate a visualization that includes the number of tickets resolved in the past five months and the predicted number of tickets to be resolved in the next month (e.g., in a line graph, in a bar graph, and/or the like). In some implementations, the data analytics platform 110 may generate the visualization that includes the prediction based on one or more selections received from the user device 105 similar to the manner in which the data analytics platform 110 generated visualizations for descriptive analytics described with respect to FIG. 1A.

Additionally, or alternatively, the data analytics platform 110 may generate and/or provide, to the user device 105, an alert based on the performance indicator satisfying a threshold. In some implementations, the data analytics platform 110 may receive real-time or near real-time process data, monitor the performance indicator based on the received process data, and generate and/or provide, to the user device 105, an alert based on the performance indicator satisfying the threshold. For example, the data analytics platform 110 may establish the threshold based on historical data, user input from the user device 105, and/or the like and, based on real-time or near real-time process data indicating that the performance indicator is predicted to satisfy the threshold, generate and/or provide, to the user device 105, the alert. In this way, the data analytics platform 110 may provide one or more alerts so that pro-active actions may be taken based on predicted values of the performance indicator.

As shown in FIG. 1C, and by reference number 150, the user device 105 may provide, to the data analytics platform 110, a request for a recommendation. In some implementations, the request for the recommendation may include a target value of the performance indicator. For example, the user device 105 may provide, to the data analytics platform 110, a request for a recommendation to achieve the target value of the performance indicator.

As shown in FIG. 1C, and by reference number 155, the data analytics platform 110 may determine a type of the machine learning model. In some implementations, the data analytics platform 110 may determine whether the machine learning model is a regression model, a classification model, a decision tree model, a random forest model, a neural network model, and/or the like. For example, the data analytics platform 110 may determine whether the performance predicting model is a regression model.

As shown in FIG. 1C, and by reference number 160, the data analytics platform 110 may perform a regression prescription method and/or a classification prescription method on the machine learning model. In some implementations, the data analytics platform 110 may perform, based on the type of the machine learning model, the regression prescription method and/or the classification prescription method. For example, the data analytics platform 110 may perform, based on determining whether the performance predicting model is a regression model, the regression prescription method and/or the classification prescription method.

In some implementations, the data analytics platform 110 may perform, based on determining that the performance predicting model is a regression model, the regression prescription method. In some implementations, the data analytics platform 110 may, when performing the regression prescription method, acquire the predicted value of the performance indicator (e.g., from the performance predicting model, from memory, and/or the like), and acquire the target value of the performance indicator (e.g., from the request for the recommendation, from memory, and/or the like).

In some implementations, the data analytics platform 110 may, when performing the regression prescription method and based on the performance predicting model, determine a rate of change of the performance indicator with respect to each feature of the plurality of features to generate first results (e.g., exclusive results and/or the like). In some implementations, when determining the rate of change of the performance indicator with respect to each feature of the plurality of features, the data analytics platform 110 may differentiate the machine learning model with respect to each feature of the plurality of features to generate the first results.

For example, the following equation may represent the machine learning model (e.g., the performance predicting model and/or the like):

Y=a₁X₁+a₂X₂+a₃X₃+ . . . +aₙXₙ Equation 1:

where Y is the performance indicator, X₁, X₂, X₃, . . . , Xₙ are the features, and a₁, a₂, a₃, . . . , aₙ are coefficients. For the present example, y may represent the predicted value of the performance indicator, and y_{d} may represent the target value of the performance indicator. Thus, a change, Δy, in the performance indicator to achieve the target value of the performance indicator may be represented by the following equation:

Δy=(y_{d}−y). Equation 2:

In the present example, to determine a change ΔX₁ in feature X₁ to achieve the target value of the performance indicator, the data analytics platform 110 may differentiate the machine learning model with respect to feature X₁ to obtain the following equation:

$$\frac{dY}{{dX}_{1}} = {a}_{1} * 1 + {a}_{2} \frac{{dX}_{2}}{{dX}_{1}} + {a}_{3} \frac{{dX}_{3}}{{dX}_{1}} + ⋯ + {a}_{n} \frac{{dX}_{n}}{{dX}_{1}} . \qquad Equation 3$$

To solve Equation 3, the data analytics platform 110 may determine, based on the machine learning model and for each feature of the plurality of features, a rate of change of each feature with respect to other features of the plurality of features to generate second results (e.g., multi collinear results and/or the like). In some implementations, the data analytics platform 110 may use third order polynomials to represent a relationship between a feature and each of the other features, such as the following equations (Equations 4):

X₂=p₂₀+p₂₁X₁+p₂₂x₁²+p₂₃X₁³.

X₃=p₃₀+p₃₁X₁+p₃₂X₁²+p₃₃X₁³

. . . = . . . + . . . + . . . + . . .

Xₙ=pₙ₀+pₙ₁X₁+pₙ₂X₁²+pₙ₃X₁³

In some implementations, by using third order polynomials when the machine learning model is a first order polynomial, the data analytics platform 110 may decrease a modelling bias, thereby improving recommendations.

In some implementations, the data analytics platform 110 may differentiate the third order polynomials with respect to feature X₁ to obtain the following equations (Equations 5):

$$\frac{{dX}_{2}}{{dX}_{1}} = {p}_{21} + 2 * {p}_{22} {X}_{1} + 3 * {p}_{23} {X}_{1}^{2}$$

$$\frac{{dX}_{3}}{{dX}_{1}} = {p}_{31} + 2 * {p}_{32} {X}_{1} + 3 * {p}_{33} {X}_{1}^{2}$$

$$… = … + … + …$$

$$\frac{{dX}_{n}}{{dX}_{1}} = {p}_{n 1} + 2 * {p}_{n 2} {X}_{1} + 3 * {p}_{n 3} {X}_{1}^{2} .$$

In some implementations, the data analytics platform 110 may use data used to generate the predicted value y of the performance indicator to create a test record as shown in Table 1 below.

TABLE 1

| | | | | |
|---|---|---|---|---|
| Y | X₁ | X₂ | . . . | Xₙ |
| y | x₁ | x₂ | . . . | xₙ |

In some implementations, the data analytics platform 110 may use the test record to substitute values into the differentiated third order polynomials to obtain the following equations (Equations 6):

$${[ \frac{{dX}_{2}}{{dX}_{1}} ]}_{{X}_{1} = {x}_{1}} = {p}_{21} + 2 * {p}_{22} {x}_{1} + 3 * {p}_{23} {x}_{1}^{2} = {{k}_{2} \\ [ \frac{{dX}_{3}}{{dX}_{1}} ]}_{{X}_{1} = {x}_{1}} = {p}_{31} + 2 * {p}_{32} {x}_{1} + 3 * {p}_{33} {x}_{1}^{2} = {k}_{3}$$

$$… … {… \\ [ \frac{{dX}_{n}}{{dX}_{1}} ]}_{{X}_{1} = {x}_{1}} = {p}_{n 1} + 2 * {p}_{n 2} {x}_{1} + 3 * {p}_{n 3} {x}_{1}^{2} = {k}_{n} .$$

In some implementations, the data analytics platform 110 may use the equations above (Equations 6) to represent the relationships between the feature X₁ and the other features X₂, X₃, . . . , Xₙ.

In some implementations, the data analytics platform 110 may substitute the values of

$${[ \frac{{dX}_{2}}{{dX}_{1}} ]}_{{X}_{1} = {x}_{1}} , {[ \frac{{dX}_{3}}{{dX}_{1}} ]}_{{X}_{1} = {x}_{1}} , … , {[ \frac{{dX}_{n}}{{dX}_{1}} ]}_{{X}_{1} = {x}_{1}}$$

and Δy into Equation 3 to obtain the following:

$${[ \frac{Δ y}{Δ {X}_{1}} ]}_{{X}_{1} = {x}_{1}} = {a}_{1} + {a}_{2} {k}_{2} + {a}_{3} {k}_{3} + ⋯ + {a}_{n} {{k}_{n} \\ [ \frac{( {y}_{d} - y )}{Δ {X}_{1}} ]}_{{X}_{1} = {x}_{1}} = {a}_{1} + {a}_{2} {k}_{2} + {a}_{3} {k}_{3} + ⋯ + {a}_{n} {k}_{n}$$

$$Δ {X}_{1} = [ \frac{( {y}_{d} - y )}{{a}_{1} + {a}_{2} {k}_{2} + {a}_{3} {k}_{3} + ⋯ + {a}_{n} {k}_{n}} ] .$$

Thus, the data analytics platform 110 may determine, using the regression prescription method, a change ΔX₁ in feature X₁ to achieve the target value y_{d} of the performance indicator. In some implementations, the data analytics platform 110 may determine, using the regression prescription method, changes ΔX₂, ΔX₃, . . . , ΔXₙ in the other features X₂, X₃, . . . , Xₙ to achieve the target value y_{d} of the performance indicator.

Additionally, or alternatively, the data analytics platform 110 may determine changes ΔX₂, ΔX₃, . . . , ΔXₙ in the other features X₂, X₃, . . . , Xₙ caused by the change ΔX₁ in feature X₁ to achieve the target value y_{d} of the performance indicator. For example, the data analytics platform 110 may substitute the equation for the change ΔX₁ in feature X₁:

$$Δ {X}_{1} = [ \frac{( {y}_{d} - y )}{{a}_{1} + {a}_{2} {k}_{2} + {a}_{3} {k}_{3} + ⋯ + {a}_{n} {k}_{n}} ]$$

into the following equation (also described above):

$${[ \frac{{dX}_{2}}{{dX}_{1}} ]}_{{X}_{1} = {x}_{1}} = {p}_{21} + 2 * {p}_{22} {x}_{1} + 3 * {p}_{23} {x}_{1}^{2} = {k}_{2}$$

to obtain a change ΔX₂ in feature X₂ caused by the change ΔX₁ in feature X₁ to achieve the target value y_{d} of the performance indicator:

$$Δ {X}_{2} = {k}_{2} * [ \frac{( {y}_{d} - y )}{{a}_{1} + {a}_{2} {k}_{2} + {a}_{3} {k}_{3} + ⋯ + {a}_{n} {k}_{n}} ] .$$

In some implementations, the data analytics platform 110 may determine, using the regression prescription method, changes ΔX₃, ΔX₄, . . . , ΔXₙ in the other features X₃, X₄, . . . , Xₙ caused by the change ΔX₁ in feature X₁ to achieve the target value y_{d} of the performance indicator.

Thus, the data analytics platform 110 may perform the regression prescription method to determine a change in each feature to achieve the target value of the performance indicator, changes in other features caused by the change in each feature to achieve the target value of the performance indicator, and/or the like. In this way, the data analytics platform 110 may conserve computing resources (e.g., processing resources, memory resources, power resources, communication resources, and/or the like) and/or network resources that would otherwise be consumed by repeatedly simulating changes using the machine learning model until the predicted value matched the target value.

In some implementations, the data analytics platform 110 may perform, based on determining that the machine learning model (e.g., the performance predicting model) is not a regression model, the classification prescription method. In some implementations, the data analytics platform 110 may, when performing the classification prescription method, acquire the predicted value of the performance indicator (e.g., from the performance predicting model, from memory, and/or the like), and acquire the target value of the performance indicator (e.g., from the request for the recommendation, from memory, and/or the like).

In some implementations, the data analytics platform 110 may, when performing the classification prescription method, determine whether the plurality of features are numerical. In some implementations, the data analytics platform 110 may, based on determining that the plurality of features are not numerical, obtain, using a model explainer, feature importance information. In some implementations, the model explainer generates information (e.g., feature importance information and/or the like) describing one or more decision boundaries of a machine learning model to provide an understandable explanation of the machine learning model. For example, the data analytics platform 110 may process, using the model explainer, the machine learning model to determine feature importance information, where the feature importance information includes an impact of each feature on the performance indicator, features associated with the performance indicator, a likelihood of each feature being associated with the performance indicator, one or more examples indicating how the machine learning model associated one or more features with the performance indicator, and/or the like. In some implementations, the data analytics platform 110 may determine, based on the feature importance information, a change in each feature to achieve the target value of the performance indicator.

In some implementations, the data analytics platform 110 may, based on determining that the plurality of features are numerical, perform the regression prescription method described herein to determine a change in each feature to achieve the target value of the performance indicator, changes in other features caused by the change in each feature to achieve the target value of the performance indicator, and/or the like. In this way, the data analytics platform 110 may conserve computing resources (e.g., processing resources, memory resources, power resources, communication resources, and/or the like) and/or network resources that would otherwise be consumed by repeatedly simulating changes using the machine learning model until the predicted value matched the target value.

In some implementations, the data analytics platform 110 may, based on determining a change in each feature to achieve the target value of the performance indicator, changes in other features caused by the change in each feature to achieve the target value of the performance indicator, and/or the like, generate one or more recommendations to achieve the target value of the performance indicator. In some implementations, the data analytics platform 110 may determine, from among the changes in each feature to achieve the target value of the performance indicator, a change in a particular feature that, when the change in the particular feature is implemented, conserves computing resources, network resources, financial resources, and/or the like (e.g., as compared to other changes in other features and/or the like) and generate a recommendation to implement the change in the particular feature. For example, the data analytics platform 110 may determine that automating the particular feature may achieve the target value of the performance indicator. Additionally, or alternatively, the data analytics platform 110 may, based on determining that automating the particular feature may achieve the target value of the performance indicator, perform one or more actions to automate the particular feature.

As shown in FIG. 1D, and by reference number 165, the data analytics platform 110 may provide a recommendation to the user device 105. In some implementations, the data analytics platform 110 may provide the recommendation to the user device 105 based on determining a change in each feature to achieve the target value of the performance indicator, changes in other features caused by the change in each feature to achieve the target value of the performance indicator, and/or the like. For example, the data analytics platform 110 may provide, to the user device 105, the change in each feature to achieve the target value of the performance indicator, changes in other features caused by the change in each feature to achieve the target value of the performance indicator, and/or the like. In some implementations, the data analytics platform 110 may provide the recommendation to the user device 105 for display by the user device 105.

Additionally, or alternatively, the data analytics platform 110 may automatically generate and/or provide the recommendation to the user device 105. For example, when providing the prediction to the user device 105 as shown in FIG. 1B and by reference number 145, the data analytics platform 110 may automatically generate and/or provide the recommendation to the user device 105 with the prediction.

As shown in FIG. 1D, and by reference number 170, the user device 105 may provide, to the data analytics platform 110, a request for a visualization. In some implementations, the request for the visualization may include a request for a visualization based on descriptive analytics (as described herein with respect to FIG. 1A), the prediction (as described herein with respect to reference number 145 in FIG. 1B), the recommendation, and/or the like. For example, and as described herein with respect to FIGS. 1E and 1F, the request for the visualization may include a request for a visualization of descriptive analytics, predictive analytics, and prescriptive analytics.

As shown in FIG. 1D, and by reference number 175, the data analytics platform 110 may provide, to the user device 105, a visualization user interface. For example, the data analytics platform 110 may provide the visualization user interface based on the request for visualization. Additionally, or alternatively, the data analytics platform 110 may provide the visualization user interface based on generating the recommendation.

As shown in FIG. 1E, based on receiving the visualization user interface from the data analytics platform 110, user device 105 may provide the visualization user interface for display. In some implementations, the visualization user interface may include options for selection by a user of the user device 105. For example, and as shown in FIG. 1E, the options may include selecting an entity (e.g., an entity associated with the plurality of features), an attribute of the entity, an aggregate for the attribute, a feature of the attribute, an aggregate for the feature, a characteristic of the feature by which the data may be sliced, a type of visualization, and/or the like. After the user selects the options and confirms the options by selecting a submit button, the user device 105 may provide the selections to the data analytics platform 110. Additionally, or alternatively, the visualization user interface may permit a user of the user device 105 to perform drag and/or drop functions to select options.

For example, and as described herein with respect to FIG. 1A, the user may, using the visualization user interface, select to generate a chart on ticket data showing total effort spent monthly in resolving tickets, sliced by priority. In some implementations, the user device 105 may provide, to the data analytics platform 110, selections of “ticket” for the entity associated with the plurality of features, “resolved date” for the attribute of the entity, “monthly” for the aggregate for the attribute, “effort” for the feature, of the plurality of features, of the attribute, “sum” for the aggregate for the feature, “priority” for the characteristic of a feature by which the data may be sliced, and “chart” for the type of visualization.

In some implementations, the data analytics platform 110 may process, based on the selections, the data associated with the plurality of features and the performance indicator to generate a visualization. In some implementations, and as described herein, the data analytics platform 110 may process, based on the selections, the data to provide descriptive analytics (as described herein with respect to FIG. 1A), the prediction (as described herein with respect to reference number 145 in FIG. 1B), the recommendation, and/or the like to generate the visualization.

For example, and as shown in FIG. 1F, the data analytics platform 110 may generate the visualization to include descriptive analytics of historical data, predictive analytics of a predicted performance indicator, one or more observations regarding the historical data and/or the predicted performance indicator, one or more recommendations, and/or the like. As shown in FIG. 1F, the data analytics platform 110 may generate the visualization to include ticket data sliced by priority, where the tickets are identified by a unique identifier “A, B, C . . . ” (e.g., a ticket number, a ticket label, and/or the like). As shown in a lower portion of FIG. 1F, the tickets are sliced by priority with highest priority tickets identified with the darkest shading and grouped at the top of a table and lower priority tickets identified with lighter shading and grouped below the highest priority tickets in order based on priority. Additionally, or alternatively, the visualization user interface may display the ticket data sliced by other characteristics, features, and/or the like of the tickets, such as features of the process being used to resolve the ticket, characteristics of the ticket, a likelihood of resolving the ticket, and/or the like. In some implementations, the visualization user interface may display, based on user input selecting, hovering over, and/or the like a ticket in the table, detailed information regarding the ticket, such as features of the process being used to resolve the ticket, characteristics of the ticket, a likelihood of resolving the ticket, and/or the like.

In some implementations, the data analytics platform 110 may generate the visualization to include ticket data showing total effort spent monthly in resolving tickets and a predicted total effort spent for the next month. For example, and as shown in the upper left portion of FIG. 1F, the visualization may include a bar graph showing total effort spent in resolving tickets for January, February, March, April, and May and a predicted total effort spent for June. In some implementations, the data analytics platform 110 may determine the predicted total effort and/or another performance indicator using the machine learning model as described herein with respect to FIG. 1B.

In some implementations, the data analytics platform 110 may generate the visualization to include observations regarding the ticket data and/or recommendations based on the ticket data. For example, and as shown in the upper right portion of FIG. 1F, the visualization may include text indicating that tickets D, F, and G, are reducing a likelihood of successfully completing a project, where the tickets represent processes and/or sub-processes of the project.

In some implementations, and as shown in the upper right portion of FIG. 1F, the visualization may include text including a recommendation that features, analysis and correlation, of a process and/or sub-process be automated to achieve a target value of a performance indicator. For example, the data analytics platform 110 may generate the recommendation by performing the regression prescription method and/or the classification prescription method as described herein with respect to FIGS. 1C and 1D.

In this way, the data analytics platform 110 may provide, to the user device 105, the visualization user interface to permit the user device 105 to select aspects of visualizations generated by the data analytics platform 110, where the visualizations include descriptive analytics (as described herein with respect to FIG. 1A), predictive analytics (as described herein with respect to FIG. 1B), and prescriptive analytics (as described herein with respect to FIGS. 1C and 1D), and/or the like.

As indicated above, FIGS. 1A-1F are provided merely as one or more examples. Other examples may differ from what is described with regard to FIGS. 1A-1F.

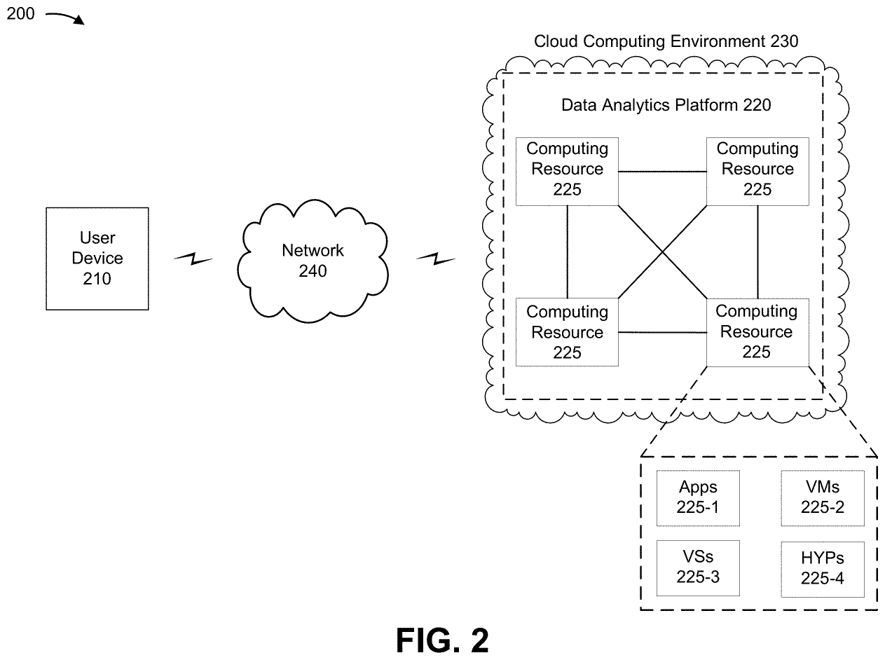

FIG. 2 is a diagram of an example environment 200 in which systems and/or methods described herein may be implemented. As shown in FIG. 2, environment 200 may include a user device 210, a data analytics platform 220, and a cloud computing environment with a computing resource 225. Devices of environment 200 may interconnect via wired connections, wireless connections, or a combination of wired and wireless connections.

User device 210 includes one or more devices capable of receiving, generating, storing, processing, and/or providing information associated with providing a user interface associated with data analytics. For example, user device 210 may include a communication and/or computing device, such as a mobile phone (e.g., a smart phone, a radiotelephone, and/or the like), a laptop computer, a tablet computer, a handheld computer, a gaming device, a wearable communication device (e.g., a smart wristwatch, a pair of smart eyeglasses, and/or the like), or a similar type of device. In some implementations, user device 210 corresponds to user device 105 shown in FIG. 1A.

Data analytics platform 220 includes one or more computing resources assigned to receive process data, predict values of performance indicators of processes, and provide recommendations for achieving target values of performance indicators, and/or the like. For example, data analytics platform 220 may be a platform implemented by cloud computing environment 230 that may determine whether a machine learning model is a regression model and perform a regression prescription method and/or a classification prescription method to generate a recommendation. In some implementations, data analytics platform 220 is implemented by computing resources 225 of cloud computing environment 230. Data analytics platform 220 may include a server device or a group of server devices. In some implementations, data analytics platform 220 may be hosted in cloud computing environment 230. Notably, while implementations described herein may describe data analytics platform 220 as being hosted in cloud computing environment 230, in some implementations, data analytics platform 220 may be non-cloud-based or may be partially cloud-based. In some implementations, data analytics platform 220 corresponds to data analytics platform 110 shown in FIG. 1A.

Cloud computing environment 230 includes an environment that delivers computing as a service, whereby shared resources, services, etc. may be provided to receive process data, predict values of performance indicators of processes, and provide recommendations for achieving target values of performance indicators, and/or the like. Cloud computing environment 230 may provide computation, software, data access, storage, and/or other services that do not require end-user knowledge of a physical location and configuration of a system and/or a device that delivers the services. As shown, cloud computing environment 230 may include data analytics platform 220 and computing resource 225.

Computing resource 225 includes one or more personal computers, workstation computers, server devices, or another type of computation and/or communication device. In some implementations, computing resource 225 may host data analytics platform 220. The cloud resources may include compute instances executing in computing resource 225, storage devices provided in computing resource 225, data transfer devices provided by computing resource 225, and/or the like. In some implementations, computing resource 225 may communicate with other computing resources 225 via wired connections, wireless connections, or a combination of wired and wireless connections.

As further shown in FIG. 2, computing resource 225 may include a group of cloud resources, such as one or more applications (“APPs”) 225-1, one or more virtual machines (“VMs”) 225-2, virtualized storage (“VSs”) 225-3, one or more hypervisors (“HYPs”) 225-4, and/or the like.

Application 225-1 includes one or more software applications that may be provided to or accessed by user device 210. Application 225-1 may eliminate a need to install and execute the software applications on user device 210. For example, application 225-1 may include software associated with data analytics platform 220 and/or any other software capable of being provided via cloud computing environment 230. In some implementations, one application 225-1 may send/receive information to/from one or more other applications 225-1, via virtual machine 225-2.

Virtual machine 225-2 includes a software implementation of a machine (e.g., a computer) that executes programs like a physical machine. Virtual machine 225-2 may be either a system virtual machine or a process virtual machine, depending upon use and degree of correspondence to any real machine by virtual machine 225-2. A system virtual machine may provide a complete system platform that supports execution of a complete operating system (“OS”). A process virtual machine may execute a single program and may support a single process. In some implementations, virtual machine 225-2 may execute on behalf of a user (e.g., user device 210), and may manage infrastructure of cloud computing environment 230, such as data management, synchronization, or long-duration data transfers.

Virtualized storage 225-3 includes one or more storage systems and/or one or more devices that use virtualization techniques within the storage systems or devices of computing resource 225. In some implementations, within the context of a storage system, types of virtualizations may include block virtualization and file virtualization. Block virtualization may refer to abstraction (or separation) of logical storage from physical storage so that the storage system may be accessed without regard to physical storage or heterogeneous structure. The separation may permit administrators of the storage system flexibility in how the administrators manage storage for end users. File virtualization may eliminate dependencies between data accessed at a file level and a location where files are physically stored. This may enable optimization of storage use, server consolidation, and/or performance of non-disruptive file migrations.

Hypervisor 225-4 provides hardware virtualization techniques that allow multiple operating systems (e.g., “guest operating systems”) to execute concurrently on a host computer, such as computing resource 225. Hypervisor 225-4 may present a virtual operating platform to the “guest operating systems” and may manage the execution of the guest operating systems. Multiple instances of a variety of operating systems may share virtualized hardware resources.

Network 240 includes one or more wired and/or wireless networks. For example, network 240 may include a cellular network (e.g., a long-term evolution (LTE) network, a code division multiple access (CDMA) network, a 3G network, a 4G network, a 5G network, another type of next generation network, and/or the like), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, a cloud computing network, and/or the like, and/or a combination of these or other types of networks.

The number and arrangement of devices and networks shown in FIG. 2 are provided as one or more examples. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of environment 200 may perform one or more functions described as being performed by another set of devices of environment 200.

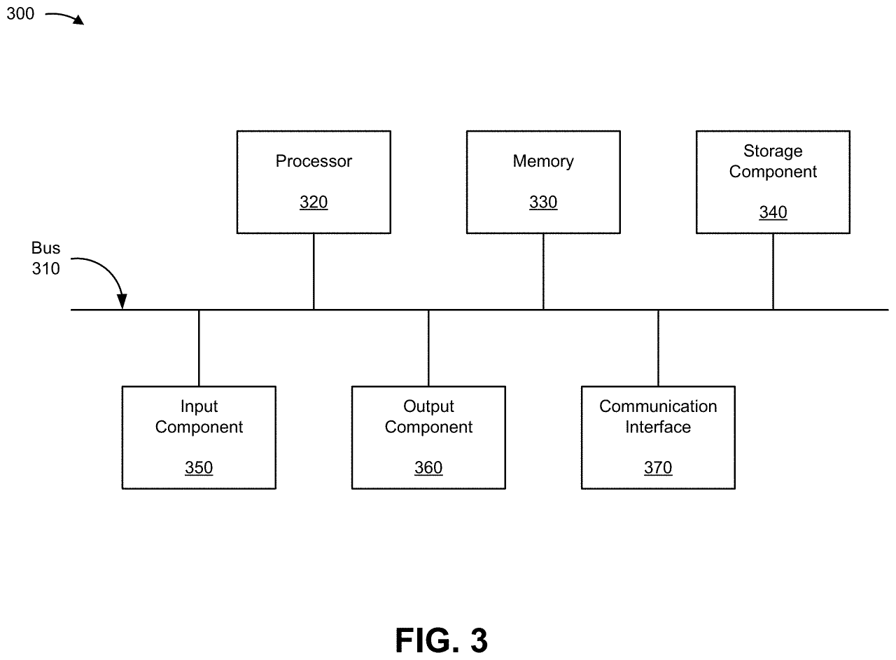

FIG. 3 is a diagram of example components of a device 300. Device 300 may correspond to user device 210, data analytics platform 220, and/or computing resource 225. In some implementations, user device 210, data analytics platform 220, and/or computing resource 225 may include one or more devices 300 and/or one or more components of device 300. As shown in FIG. 3, device 300 may include a bus 310, a processor 320, a memory 330, a storage component 340, an input component 350, an output component 360, and/or a communication interface 370.

Bus 310 includes a component that permits communication among multiple components of device 300. Processor 320 is implemented in hardware, firmware, and/or a combination of hardware and software. Processor 320 takes the form of a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some implementations, processor 320 includes one or more processors capable of being programmed to perform a function. Memory 330 includes a random access memory (RAM), a read only memory (ROM), and/or another type of dynamic or static storage device (e.g., a flash memory, a magnetic memory, and/or an optical memory) that stores information and/or instructions for use by processor 320.

Storage component 340 stores information and/or software related to the operation and use of device 300. For example, storage component 340 may include a hard disk (e.g., a magnetic disk, an optical disk, and/or a magneto-optic disk), a solid state drive (SSD), a compact disc (CD), a digital versatile disc (DVD), a floppy disk, a cartridge, a magnetic tape, and/or another type of non-transitory computer-readable medium, along with a corresponding drive.

Input component 350 includes a component that permits device 300 to receive information, such as via user input (e.g., a touch screen display, a keyboard, a keypad, a mouse, a button, a switch, and/or a microphone). Additionally, or alternatively, input component 350 may include a component for determining location (e.g., a global positioning system (GPS) component) and/or a sensor (e.g., an accelerometer, a gyroscope, an actuator, another type of positional or environmental sensor, and/or the like). Output component 360 includes a component that provides output information from device 300 (via, e.g., a display, a speaker, a haptic feedback component, an audio or visual indicator, and/or the like).

Communication interface 370 includes a transceiver-like component (e.g., a transceiver, a separate receiver, a separate transmitter, and/or the like) that enables device 300 to communicate with other devices, such as via a wired connection, a wireless connection, or a combination of wired and wireless connections. Communication interface 370 may permit device 300 to receive information from another device and/or provide information to another device. For example, communication interface 370 may include an Ethernet interface, an optical interface, a coaxial interface, an infrared interface, a radio frequency (RF) interface, a universal serial bus (USB) interface, a Wi-Fi interface, a cellular network interface, and/or the like.

Device 300 may perform one or more processes described herein. Device 300 may perform these processes based on processor 320 executing software instructions stored by a non-transitory computer-readable medium, such as memory 330 and/or storage component 340. As used herein, the term “computer-readable medium” refers to a non-transitory memory device. A memory device includes memory space within a single physical storage device or memory space spread across multiple physical storage devices.

Software instructions may be read into memory 330 and/or storage component 340 from another computer-readable medium or from another device via communication interface 370. When executed, software instructions stored in memory 330 and/or storage component 340 may cause processor 320 to perform one or more processes described herein. Additionally, or alternatively, hardware circuitry may be used in place of or in combination with software instructions to perform one or more processes described herein. Thus, implementations described herein are not limited to any specific combination of hardware circuitry and software.

The number and arrangement of components shown in FIG. 3 are provided as an example. In practice, device 300 may include additional components, fewer components, different components, or differently arranged components than those shown in FIG. 3. Additionally, or alternatively, a set of components (e.g., one or more components) of device 300 may perform one or more functions described as being performed by another set of components of device 300.

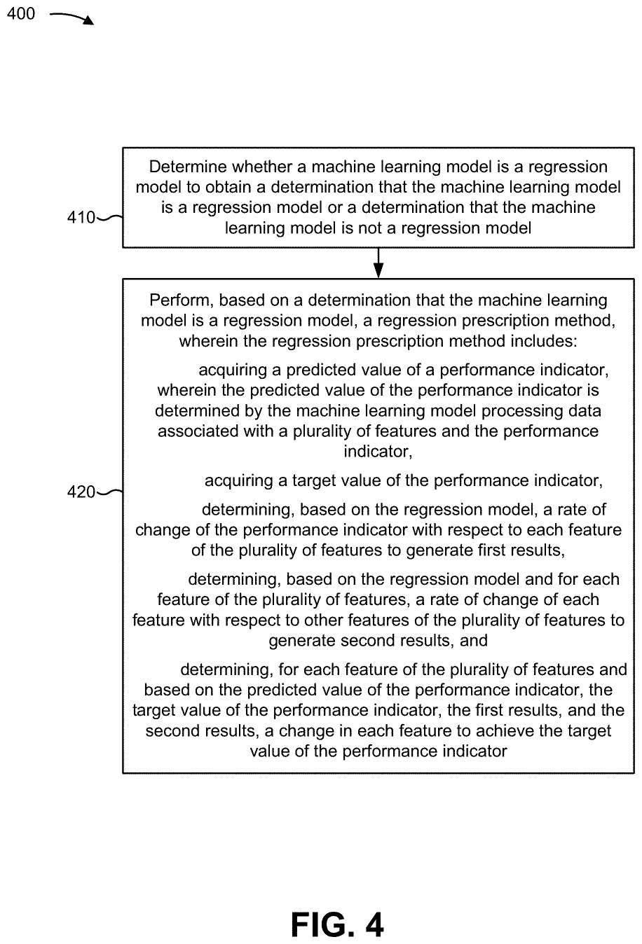

FIG. 4 is a flow chart of an example process 400 for determining a change in one or more features to achieve a target value of a performance indicator. In some implementations, one or more process blocks of FIG. 4 may be performed by a data analytics platform (e.g., data analytics platform 220). In some implementations, one or more process blocks of FIG. 4 may be performed by another device or a group of devices separate from or including the data analytics platform, such as a user device (e.g., user device 210), a computing resource (e.g., computing resource 225), and/or the like.

As shown in FIG. 4, process 400 may include determining whether a machine learning model is a regression model to obtain a determination that the machine learning model is a regression model or a determination that the machine learning model is not a regression model (block 410). For example, the data analytics platform (e.g., using processor 320, memory 330, storage component 340, input component 350, output component 360, communication interface 370, and/or the like) may determine whether a machine learning model is a regression model to obtain a determination that the machine learning model is a regression model or a determination that the machine learning model is not a regression model, as described above.

As further shown in FIG. 4, process 400 may include performing, based on a determination that the machine learning model is a regression model, a regression prescription method, wherein the regression prescription method includes: acquiring a predicted value of a performance indicator, wherein the predicted value of the performance indicator is determined by the machine learning model processing data associated with a plurality of features and the performance indicator, acquiring a target value of the performance indicator, determining, based on the regression model, a rate of change of the performance indicator with respect to each feature of the plurality of features to generate first results, determining, based on the regression model and for each feature of the plurality of features, a rate of change of each feature with respect to other features of the plurality of features to generate second results, and determining, for each feature of the plurality of features and based on the predicted value of the performance indicator, the target value of the performance indicator, the first results, and the second results, a change in each feature to achieve the target value of the performance indicator (block 420). For example, the data analytics platform (e.g., using processor 320, memory 330, storage component 340, input component 350, output component 360, communication interface 370, and/or the like) may perform, based on a determination that the machine learning model is a regression model, a regression prescription method, as described above. In some implementations, the regression prescription method includes acquiring a predicted value of a performance indicator, determining, based on the regression model, a rate of change of the performance indicator with respect to each feature of the plurality of features to generate first results, determining, based on the regression model and for each feature of the plurality of features, a rate of change of each feature with respect to other features of the plurality of features to generate second results, and determining, for each feature of the plurality of features and based on the predicted value of the performance indicator, the target value of the performance indicator, the first results, and the second results, a change in each feature to achieve the target value of the performance indicator. In some implementations, the predicted value of the performance indicator is determined by the machine learning model processing data associated with a plurality of features and the performance indicator.

Process 400 may include additional implementations, such as any single implementation or any combination of implementations described below and/or in connection with one or more other processes described elsewhere herein.

In a first implementation, process 400 includes performing, based on a determination that the machine learning model is not a regression model, a classification prescription method, wherein the classification prescription method includes: acquiring the predicted value of the performance indicator, acquiring the target value of the performance indicator, determining whether the plurality of features are numerical, and based on determining that the plurality of features are not numerical: obtaining, using a model explainer, feature importance information, and determining, based on the feature importance information, a change in each feature to achieve the target value of the performance indicator, or based on determining that the plurality of features are numerical, performing the regression prescription method, to determine a change in each feature to achieve the target value of the performance indicator.

In a second implementation, alone or in combination with the first implementation, process 400 includes generating, based on the change in each feature to achieve the target value of the performance indicator, a recommendation to achieve the target value of the performance indicator.

In a third implementation, alone or in combination with one or more of the first and second implementations, determining, based on the regression model, the rate of change of the performance indicator with respect to each feature of the plurality of features comprises differentiating the regression model with respect to each feature of the plurality of features.

In a fourth implementation, alone or in combination with one or more of the first through third implementations, process 400 includes selecting a feature of the plurality of features and automatically implementing the change in the feature to achieve the target value of the performance indicator.

In a fifth implementation, alone or in combination with one or more of the first through fourth implementations, the plurality of features and the performance indicator are associated with a process, and the process is at least one of a service delivery process, a software engineering process, a software testing process, a development operations process, an agile process, an industry practices process, a process management process, or a project management process.

In a sixth implementation, alone or in combination with one or more of the first through fifth implementations, process 400 includes receiving selections of at least one of an entity associated with the plurality of features, an attribute of the entity, an aggregate for the attribute, a feature, of the plurality of features, of the attribute, an aggregate for the feature, or a type of visualization, processing the data associated with the plurality of features and the performance indicator to generate, based on the selections, a visualization of the data associated with the selections, and displaying the visualization of the data associated with the selections.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel.

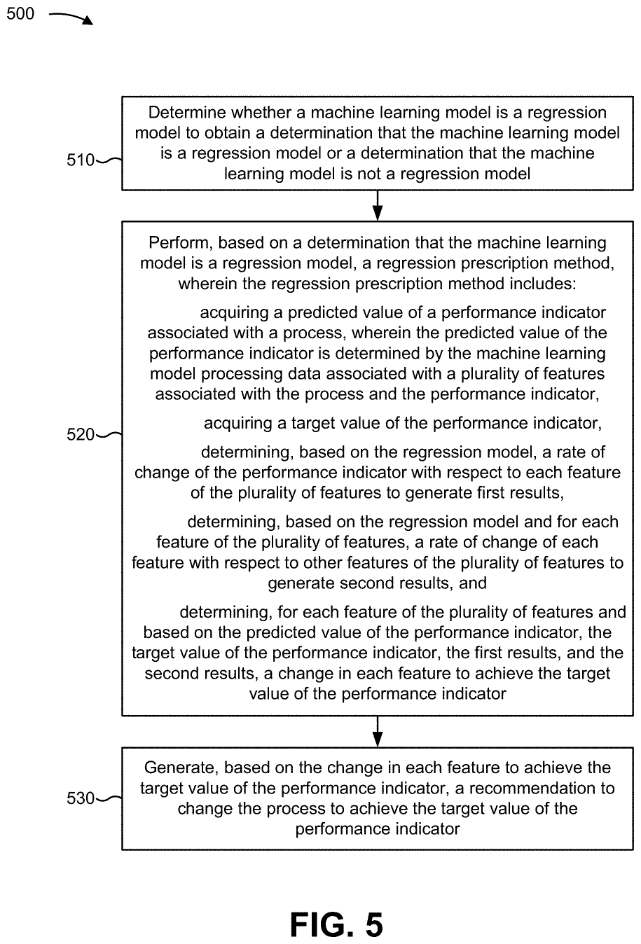

FIG. 5 is a flow chart of an example process 500 for generating a recommendation to change a process to achieve a target value of a performance indicator. In some implementations, one or more process blocks of FIG. 5 may be performed by a data analytics platform (e.g., data analytics platform 220). In some implementations, one or more process blocks of FIG. 5 may be performed by another device or a group of devices separate from or including the data analytics platform, such as a user device (e.g., user device 210), a computing resource (e.g., computing resource 225), and/or the like.

As shown in FIG. 5, process 500 may include determining whether a machine learning model is a regression model to obtain a determination that the machine learning model is a regression model or a determination that the machine learning model is not a regression model (block 510). For example, the data analytics platform (e.g., using processor 320, memory 330, storage component 340, input component 350, output component 360, communication interface 370, and/or the like) may determine whether a machine learning model is a regression model to obtain a determination that the machine learning model is a regression model or a determination that the machine learning model is not a regression model, as described above.

As further shown in FIG. 5, process 500 may include performing, based on a determination that the machine learning model is a regression model, a regression prescription method, wherein the regression prescription method includes: acquiring a predicted value of a performance indicator associated with a process, wherein the predicted value of the performance indicator is determined by the machine learning model processing data associated with a plurality of features associated with the process and the performance indicator, acquiring a target value of the performance indicator, determining, based on the regression model, a rate of change of the performance indicator with respect to each feature of the plurality of features to generate first results, determining, based on the regression model and for each feature of the plurality of features, a rate of change of each feature with respect to other features of the plurality of features to generate second results, and determining, for each feature of the plurality of features and based on the predicted value of the performance indicator, the target value of the performance indicator, the first results, and the second results, a change in each feature to achieve the target value of the performance indicator (block 520). For example, the data analytics platform (e.g., using processor 320, memory 330, storage component 340, input component 350, output component 360, communication interface 370, and/or the like) may perform, based on a determination that the machine learning model is a regression model, a regression prescription method, as described above. In some implementations, the regression prescription method includes acquiring a predicted value of a performance indicator associated with a process, acquiring a target value of the performance indicator, determining, based on the regression model, a rate of change of the performance indicator with respect to each feature of the plurality of features to generate first results, determining, based on the regression model and for each feature of the plurality of features, a rate of change of each feature with respect to other features of the plurality of features to generate second results, and determining, for each feature of the plurality of features and based on the predicted value of the performance indicator, the target value of the performance indicator, the first results, and the second results, a change in each feature to achieve the target value of the performance indicator. In some implementations, the predicted value of the performance indicator is determined by the machine learning model processing data associated with a plurality of features associated with the process and the performance indicator.

As further shown in FIG. 5, process 500 may include generating, based on the change in each feature to achieve the target value of the performance indicator, a recommendation to change the process to achieve the target value of the performance indicator (block 530). For example, the data analytics platform (e.g., using processor 320, memory 330, storage component 340, input component 350, output component 360, communication interface 370, and/or the like) may generate, based on the change in each feature to achieve the target value of the performance indicator, a recommendation to change the process to achieve the target value of the performance indicator, as described above.

Process 500 may include additional implementations, such as any single implementation or any combination of implementations described below and/or in connection with one or more other processes described elsewhere herein.

In a first implementation, process 500 includes performing, based on a determination that the machine learning model is not a regression model, a classification prescription method, wherein the classification prescription method includes acquiring the predicted value of the performance indicator, acquiring the target value of the performance indicator, determining whether the plurality of features are numerical, and based on determining that the plurality of features are not numerical, obtaining, using a model explainer, feature importance information, and determining, based on the feature importance information, a change in each feature to achieve the target value of the performance indicator, or based on determining that the plurality of features are numerical, performing the regression prescription method, to determine a change in each feature to achieve the target value of the performance indicator.

In a second implementation, alone or in combination with the first implementation, process 500 includes determining, based on the second results and for each feature, changes in other features caused by the change in each feature to achieve the target value of the performance indicator, and displaying the change in each feature to achieve the target value of the performance indicator and the changes in other features caused by the change in each feature to achieve the target value of the performance indicator.

In a third implementation, alone or in combination with one or more of the first and second implementations, process 500 includes selecting a feature of the plurality of features and automatically implementing a change in the process to achieve the change in the feature to achieve the target value of the performance indicator.

In a fourth implementation, alone or in combination with one or more of the first through third implementations, the process is at least one of a service delivery process, a software engineering process, a software testing process, a development operations process, an agile process, an industry practices process, a process management process, or a project management process.

In a fifth implementation, alone or in combination with one or more of the first through fourth implementations, process 500 includes receiving selections of at least one of an entity associated with the plurality of features, an attribute of the entity, an aggregate for the attribute, a feature, of the plurality of features, of the attribute, an aggregate for the feature, or a type of visualization, processing the data associated with the plurality of features and the performance indicator to generate, based on the selections, a visualization of the data associated with the selections, and displaying the visualization of the data associated with the selections.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel.

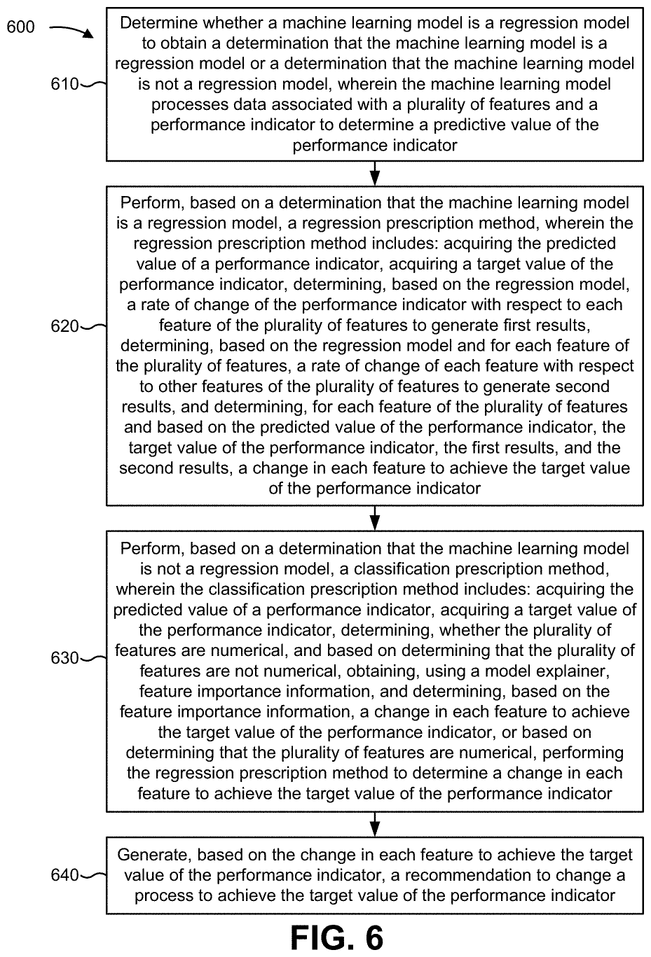

FIG. 6 is a flow chart of an example process 600 for generating a recommendation to change a process to achieve a target value of a performance indicator. In some implementations, one or more process blocks of FIG. 6 may be performed by a data analytics platform (e.g., data analytics platform 220). In some implementations, one or more process blocks of FIG. 6 may be performed by another device or a group of devices separate from or including the data analytics platform, such as a user device (e.g., user device 210), a computing resource (e.g., computing resource 225), and/or the like.

As shown in FIG. 6, process 600 may include determining whether a machine learning model is a regression model to obtain a determination that the machine learning model is a regression model or a determination that the machine learning model is not a regression model, wherein the machine learning model processes data associated with a plurality of features and a performance indicator to determine a predicted value of the performance indicator (block 610). For example, the data analytics platform (e.g., using processor 320, memory 330, storage component 340, input component 350, output component 360, communication interface 370, and/or the like) may determine whether a machine learning model is a regression model, as described above. In some implementations, the machine learning model processes data associated with a plurality of features and a performance indicator to determine a predicted value of the performance indicator.

As further shown in FIG. 6, process 600 may include performing, based on a determination that the machine learning model is a regression model, a regression prescription method, wherein the regression prescription method includes: acquiring the predicted value of the performance indicator, acquiring a target value of the performance indicator, determining, based on the regression model, a rate of change of the performance indicator with respect to each feature of the plurality of features to generate first results, determining, based on the regression model and for each feature of the plurality of features, a rate of change of each feature with respect to other features of the plurality of features to generate second results, and determining, for each feature of the plurality of features and based on the predicted value of the performance indicator, the target value of the performance indicator, the first results, and the second results, a change in each feature to achieve the target value of the performance indicator (block 620). For example, the data analytics platform (e.g., using processor 320, memory 330, storage component 340, input component 350, output component 360, communication interface 370, and/or the like) may perform, based on a determination that the machine learning model is a regression model, a regression prescription method, as described above. In some implementations, the regression prescription method includes acquiring the predicted value of the performance indicator, acquiring a target value of the performance indicator, determining, based on the regression model, a rate of change of the performance indicator with respect to each feature of the plurality of features to generate first results, determining, based on the regression model and for each feature of the plurality of features, a rate of change of each feature with respect to other features of the plurality of features to generate second results, and determining, for each feature of the plurality of features and based on the predicted value of the performance indicator, the target value of the performance indicator, the first results, and the second results, a change in each feature to achieve the target value of the performance indicator.

As further shown in FIG. 6, process 600 may include performing, based on a determination that the machine learning model is not a regression model, a classification prescription method, wherein the classification prescription method includes: acquiring the predicted value of the performance indicator, acquiring the target value of the performance indicator, determining whether the plurality of features are numerical, and based on determining that the plurality of features are not numerical: obtaining, using a model explainer, feature importance information, and determining, based on the feature importance information, a change in each feature to achieve the target value of the performance indicator, or based on determining that the plurality of features are numerical, performing the regression prescription method to determine a change in each feature to achieve the target value of the performance indicator (block 630). For example, the data analytics platform (e.g., using processor 320, memory 330, storage component 340, input component 350, output component 360, communication interface 370, and/or the like) may perform, based on a determination that the machine learning model is not a regression model, a classification prescription method, as described above. In some implementations, the classification prescription method includes acquiring the predicted value of the performance indicator, acquiring the target value of the performance indicator, determining whether the plurality of features are numerical, and based on determining that the plurality of features are not numerical: obtaining, using a model explainer, feature importance information, and determining, based on the feature importance information, a change in each feature to achieve the target value of the performance indicator, or based on determining that the plurality of features are numerical, performing the regression prescription method to determine a change in each feature to achieve the target value of the performance indicator.

As further shown in FIG. 6, process 600 may include generating, based on the change in each feature to achieve the target value of the performance indicator, a recommendation to change a process to achieve the target value of the performance indicator (block 640). For example, the data analytics platform (e.g., using processor 320, memory 330, storage component 340, input component 350, output component 360, communication interface 370, and/or the like) may generate, based on the change in each feature to achieve the target value of the performance indicator, a recommendation to change a process to achieve the target value of the performance indicator, as described above.

Process 600 may include additional implementations, such as any single implementation or any combination of implementations described below and/or in connection with one or more other processes described elsewhere herein.

In a first implementation, process 600 includes determining, based on at least one of the second results or the feature importance information and for each feature, changes in other features caused by the change in each feature to achieve the target value of the performance indicator; and displaying the change in each feature to achieve the target value of the performance indicator and the changes in other features caused by the change in each feature to achieve the target value of the performance indicator.

In a second implementation, alone or in combination with the first implementation, determining, based on the regression model, the rate of change of the performance indicator with respect to each feature of the plurality of features includes differentiating the regression model with respect to each feature of the plurality of features.

In a third implementation, alone or in combination with one or more of the first and second implementations, determining, based on the regression model and for each feature of the plurality of features, the rate of change of each feature with respect to other features of the plurality of features, includes, for each feature, generating a polynomial regression model to represent a relationship between a feature and other features, and differentiating the polynomial regression model with respect to the feature.

In a fourth implementation, alone or in combination with one or more of the first through third implementations, the polynomial regression model is a third order polynomial regression model.

In a fifth implementation, alone or in combination with one or more of the first through fourth implementations, process 600 includes determining whether the machine learning model is a decision tree model, a random forest model, and/or a neural network model.

In a sixth implementation, alone or in combination with one or more of the first through fifth implementations, the plurality of features and the performance indicator are associated with a process, and the process is at least one of a service delivery process, a software engineering process, a software testing process, a development operations process, an agile process, an industry practices process, a process management process, or a project management process.

Although FIG. 6 shows example blocks of process 600, in some implementations, process 600 may include additional blocks, fewer blocks, different blocks, or differently arranged blocks than those depicted in FIG. 6. Additionally, or alternatively, two or more of the blocks of process 600 may be performed in parallel.

The foregoing disclosure provides illustration and description, but is not intended to be exhaustive or to limit the implementations to the precise forms disclosed. Modifications and variations may be made in light of the above disclosure or may be acquired from practice of the implementations.

As used herein, the term “component” is intended to be broadly construed as hardware, firmware, and/or a combination of hardware and software.

As used herein, satisfying a threshold may, depending on the context, refer to a value being greater than the threshold, more than the threshold, higher than the threshold, greater than or equal to the threshold, less than the threshold, fewer than the threshold, lower than the threshold, less than or equal to the threshold, equal to the threshold, or the like.

Certain user interfaces have been described herein and/or shown in the figures. A user interface may include a graphical user interface, a non-graphical user interface, a text-based user interface, and/or the like. A user interface may provide information for display. In some implementations, a user may interact with the information, such as by providing input via an input component of a device that provides the user interface for display. In some implementations, a user interface may be configurable by a device and/or a user (e.g., a user may change the size of the user interface, information provided via the user interface, a position of information provided via the user interface, etc.). Additionally, or alternatively, a user interface may be pre-configured to a standard configuration, a specific configuration based on a type of device on which the user interface is displayed, and/or a set of configurations based on capabilities and/or specifications associated with a device on which the user interface is displayed.

It will be apparent that systems and/or methods described herein may be implemented in different forms of hardware, firmware, or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be designed to implement the systems and/or methods based on the description herein.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, a combination of related and unrelated items, etc.), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A method, comprising:
determining, by a device, whether a machine learning model is a regression model to obtain a determination that the machine learning model is a regression model or a determination that the machine learning model is not a regression model; and
performing, by the device and based on a determination that the machine learning model is a regression model, a regression prescription method,
wherein the regression prescription method includes:
acquiring a predicted value of a performance indicator,
wherein the predicted value of the performance indicator is determined by the machine learning model processing data associated with a plurality of features and the performance indicator,
acquiring a target value of the performance indicator,
determining, based on the regression model, a rate of change of the performance indicator with respect to each feature of the plurality of features to generate first results,
determining, based on the regression model and for each feature of the plurality of features, a rate of change of each feature with respect to other features of the plurality of features to generate second results, and
determining, for each feature of the plurality of features and based on the predicted value of the performance indicator, the target value of the performance indicator, the first results, and the second results, a change in each feature to achieve the target value of the performance indicator.

2. The method of claim 1, further comprising:
performing, based on a determination that the machine learning model is not a regression model, a classification prescription method, wherein the classification prescription method includes:
acquiring the predicted value of the performance indicator,
acquiring the target value of the performance indicator,
determining whether the plurality of features are numerical, and
based on determining that the plurality of features are not numerical:
obtaining, using a model explainer, feature importance information, and
determining, based on the feature importance information, a change in each feature to achieve the target value of the performance indicator, or
based on determining that the plurality of features are numerical, performing the regression prescription method, to determine a change in each feature to achieve the target value of the performance indicator.

3. The method of claim 1, further comprising:
generating, based on the change in each feature to achieve the target value of the performance indicator, a recommendation to achieve the target value of the performance indicator.

4. The method of claim 1, wherein determining, based on the regression model, the rate of change of the performance indicator with respect to each feature of the plurality of features comprises:
differentiating the regression model with respect to each feature of the plurality of features.

5. The method of claim 1, further comprising:
selecting a feature of the plurality of features; and
automatically implementing the change in the feature to achieve the target value of the performance indicator.

6. The method of claim 1, wherein the plurality of features and the performance indicator are associated with a process, and
wherein the process is at least one of:
a service delivery process,
a software engineering process,
a software testing process,
a development operations process,
an agile process,
an industry practices process,
a process management process, or
a project management process.

7. The method of claim 1, further comprising:
receiving selections of at least one of:
an entity associated with the plurality of features,
an attribute of the entity,
an aggregate for the attribute,
a feature, of the plurality of features, of the attribute,
an aggregate for the feature, or
a type of visualization;
processing the data associated with the plurality of features and the performance indicator to generate, based on the selections, a visualization of the data associated with the selections; and
displaying the visualization of the data associated with the selections.

8. A device, comprising:
one or more memories; and
one or more processors, communicatively coupled to the one or more memories, configured to:
determine whether a machine learning model is a regression model to obtain a determination that the machine learning model is a regression model or a determination that the machine learning model is not a regression model;
perform, based on a determination that the machine learning model is a regression model, a regression prescription method,
wherein the regression prescription method includes:
acquiring a predicted value of a performance indicator associated with a process,
wherein the predicted value of the performance indicator is determined by the machine learning model processing data associated with a plurality of features associated with the process and the performance indicator,
acquiring a target value of the performance indicator,
determining, based on the regression model, a rate of change of the performance indicator with respect to each feature of the plurality of features to generate first results,
determining, based on the regression model and for each feature of the plurality of features, a rate of change of each feature with respect to other features of the plurality of features to generate second results, and
determining, for each feature of the plurality of features and based on the predicted value of the performance indicator, the target value of the performance indicator, the first results, and the second results, a change in each feature to achieve the target value of the performance indicator; and
generate, based on the change in each feature to achieve the target value of the performance indicator, a recommendation to change the process to achieve the target value of the performance indicator.

9. The device of claim 8, wherein the one or more processors are further configured to:
perform, based on a determination that the machine learning model is not a regression model, a classification prescription method,
wherein the classification prescription method includes:
acquiring the predicted value of the performance indicator,
acquiring the target value of the performance indicator,
determining whether the plurality of features are numerical, and
based on determining that the plurality of features are not numerical:
obtaining, using a model explainer, feature importance information, and
determining, based on the feature importance information, a change in each feature to achieve the target value of the performance indicator, or
based on determining that the plurality of features are numerical,
performing the regression prescription method, to determine a change in each feature to achieve the target value of the performance indicator.

10. The device of claim 8, wherein the one or more processors are further configured to:
determine, based on the second results and for each feature, changes in other features caused by the change in each feature to achieve the target value of the performance indicator; and
display the change in each feature to achieve the target value of the performance indicator and the changes in other features caused by the change in each feature to achieve the target value of the performance indicator.

11. The device of claim 8, wherein the one or more processors are further configured to:
select a feature of the plurality of features; and
automatically implement a change in the process to achieve the change in the feature to achieve the target value of the performance indicator.

12. The device of claim 8, wherein the process is at least one of:
a service delivery process,
a software engineering process,
a software testing process,
a development operations process,
an agile process,
an industry practices process,
a process management process, or
a project management process.

13. The device of claim 8, wherein the one or more processors are further configured to:
receive selections of at least one of:
an entity associated with the plurality of features,
an attribute of the entity,
an aggregate for the attribute,
a feature, of the plurality of features, of the attribute,
an aggregate for the feature, or
a type of visualization;
process the data associated with the plurality of features and the performance indicator to generate, based on the selections, a visualization of the data associated with the selections; and
display the visualization of the data associated with the selections.

14. A non-transitory computer-readable medium storing instructions, the instructions comprising:
one or more instructions that, when executed by one or more processors, cause the one or more processors to:
determine whether a machine learning model is a regression model to obtain a determination that the machine learning model is a regression model or a determination that the machine learning model is not a regression model,
wherein the machine learning model processes data associated with a plurality of features and a performance indicator to determine a predicted value of the performance indicator;
perform, based on a determination that the machine learning model is a regression model, a regression prescription method,
wherein the regression prescription method includes:
acquiring the predicted value of the performance indicator,
acquiring a target value of the performance indicator,
determining, based on the regression model, a rate of change of the performance indicator with respect to each feature of the plurality of features to generate first results,
determining, based on the regression model and for each feature of the plurality of features, a rate of change of each feature with respect to other features of the plurality of features to generate second results, and
determining, for each feature of the plurality of features and based on the predicted value of the performance indicator, the target value of the performance indicator, the first results, and the second results, a change in each feature to achieve the target value of the performance indicator;
perform, based on a determination that the machine learning model is not a regression model, a classification prescription method,
wherein the classification prescription method includes:
acquiring the predicted value of the performance indicator,
acquiring the target value of the performance indicator,
determining whether the plurality of features are numerical, and
based on determining that the plurality of features are not numerical:
obtaining, using a model explainer, feature importance information, and
determining, based on the feature importance information,
a change in each feature to achieve the target value of the performance indicator, or
based on determining that the plurality of features are numerical, performing the regression prescription method to determine a change in each feature to achieve the target value of the performance indicator; and
generate, based on the change in each feature to achieve the target value of the performance indicator, a recommendation to change a process to achieve the target value of the performance indicator.

15. The non-transitory computer-readable medium of claim 14, wherein the one or more instructions, when executed by the one or more processors, further cause the one or more processors to:
determine, based on at least one of the second results or the feature importance information and for each feature, changes in other features caused by the change in each feature to achieve the target value of the performance indicator; and
display the change in each feature to achieve the target value of the performance indicator and the changes in other features caused by the change in each feature to achieve the target value of the performance indicator.

16. The non-transitory computer-readable medium of claim 14, wherein the one or more instructions, that cause the one or more processors to determine, based on the regression model, the rate of change of the performance indicator with respect to each feature of the plurality of features, cause the one or more processors to:
differentiate the regression model with respect to each feature of the plurality of features.

17. The non-transitory computer-readable medium of claim 14, wherein the one or more instructions, that cause the one or more processors to determine, based on the regression model and for each feature of the plurality of features, the rate of change of each feature with respect to other features of the plurality of features, cause the one or more processors to, for each feature:
generate a polynomial regression model to represent a relationship between a feature and other features; and
differentiate the polynomial regression model with respect to the feature.

18. The non-transitory computer-readable medium of claim 17, wherein the polynomial regression model is a third order polynomial regression model.

19. The non-transitory computer-readable medium of claim 14, wherein the one or more instructions, when executed by the one or more processors, further cause the one or more processors to:
determine whether the machine learning model is a decision tree model, a random forest model, and/or a neural network model.

20. The non-transitory computer-readable medium of claim 14, wherein the plurality of features and the performance indicator are associated with a process, and
wherein the process is at least one of:
a service delivery process,
a software engineering process,
a software testing process,
a development operations process,
an agile process,
an industry practices process,
a process management process, or
a project management process.
